(19) United States
(12) Patent Application Publication
(10) Pub. No.: US 2010/0278278 A1
(43) Pub. Date: Nov. 4, 2010

(54) METHOD FOR SETTING PRECODER IN OPEN LOOP MIMO SYSTEM

(75) Inventors: Wook Bong LEE, Anyang-si (KR); Hyun Soo Ko, Anyang-si (KR); Moon Il Lee, Anyang-si (KR); Bin Chul Ihm, Anyang-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/770,140

(22) Filed: Apr. 29, 2010

Related U.S. Application Data
(60) Provisional application No. 61/173,983, filed on Apr. 30, 2009.

(30) Foreign Application Priority Data
Jul. 24, 2009 (KR) 10-2009-0067708

(51) Int. Cl. H04B 7/02

(52) U.S. Cl. 375/267

(57) ABSTRACT

A feedback method of a user equipment in an open loop Multiple-Input Multiple-Output (MIMO) system is disclosed. The method includes, receiving one of a plurality of modes determined according to types of resources to be used for performing feedback from a base station, and selecting a precoding matrix from a codebook subset corresponding to the received mode, applying the selected precoding matrix, and transmitting feedback information. Different codebook subsets are configured with respect to the plurality of modes, and the codebook subset is configured by extracting a predetermined number of elements from a base codebook based on a predetermined criterion considering the characteristics of the modes.

This application claims the benefit of Korean Patent Application No. 10-2009-0067708, filed on Jul. 24, 2009, which is hereby incorporated by reference as if fully set forth herein.

This application also claims the benefit of U.S. Provisional Application Ser. No. 61/173,983, filed on Apr. 30, 2009, which is hereby incorporated by reference as if fully set forth herein.

### BACKGROUND OF THE INVENTION

1. Field of the Invention

The present invention relates to a cellular system, and more particularly, to a method for setting a precoder in an open loop Multiple-Input Multiple-Output (MIMO) system.

2. Discussion of the Related Art

First, Multiple-Input Multiple-Output (MIMO) technology to which the present invention applies will be described in brief.

The MIMO scheme refers to a scheme using multiple transmission antennas and multiple reception antennas so as to improve data transmission/reception efficiency, unlike a conventional scheme using one transmission antenna and one reception antenna. That is, in the MIMO scheme, in order to receive one message, technology for collecting and combining data fragments received via several antennas without using a single antenna path is applied. According to the MIMO technology, data transfer rate can be improved in a specific range or a system range can be increased with respect to a specific data transfer rate. That is, the MIMO technology is next-generation mobile communication technology which can be widely used in a User Equipment (UE), a repeater and the like for mobile communication. This technology is attracting considerable attention as technology capable of overcoming a limit in transfer size of mobile communication due to data communication expansion.

FIG. 1 is a diagram showing the configuration of a general MIMO system.

As shown in FIG. 1, if the number of transmitters and the number of receivers are simultaneously increased, channel transfer capacity is theoretically increased in proportion to the number of antennas, unlike the case where multiple antennas are used in only one of the transmitter or the receiver. Accordingly, frequency efficiency is remarkably improved.

After the theoretical capacity increase of the MIMO system was proved in the mid-90s, research into various technologies capable of substantially improving data transfer rate has been actively conducted up to now. Among them, some technologies have already been applied to various wireless communication standards of third-generation mobile communication and a next-generation wireless Local Area Network (LAN).

In association with the MIMO technology, various research such as research on information theory associated with MIMO communication capacity computation in various channel environments and multiple access environments, research on radio channel measurement and model derivation of the MIMO system, and research on space-time signal processing technology for improving a transfer rate and improving transmission reliability have been actively conducted.

The MIMO technology may be divided into a spatial diversity scheme for increasing transmission reliability using the same symbols passing through various channel paths and a spatial multiplexing scheme for simultaneously transmitting a plurality of different data symbols using a plurality of transmission antennas so as to improve transfer rate. In addition, recently, research on a method of adequately combining these schemes so as to obtain respective merits has been conducted.

In general, in a MIMO mode allowed in a system, since spatial resources are added, the MIMO mode is divided into a Single User MIMO (SU-MIMO) mode and a multi-User MIMO (MU-MIMO) mode, depending on how spatial resources are allocated.

FIG. 2 is a diagram showing the architecture of a downlink MIMO system of a transmitter. As shown in FIG. 2, a MIMO encoder 201 maps L (≧1) layers to Mₜ (≧L) streams. The streams are input to a precoder 202. The layers are defined by coding and modulation paths input to the MIMO encoder 201. In addition, the streams are defined by an output of the MIMO encoder 201 passing through the precoder 202.

The precoder 202 generates antenna-specific data symbols according to a selected MIMO mode so as to map the streams to antennas.

A subcarrier mapper 203 maps the antenna-specific data to OFDM symbols.

Mapping of the layers to the streams is performed by the MIMO encoder 201. The MIMO encoder 201 is a batch processor which simultaneously processes M input symbols. The input to the MIMO encoder 201 may be expressed by an M×1 vector as shown in Equation 1.

$$s = [ \begin{matrix}{s}_{1} \\ {s}_{2} \\ ⋮ \\ {s}_{M}\end{matrix} ] \qquad Equation 1$$

In Equation 1, Sᵢ denotes an i-th input symbol in one batch process. The mapping of the layers of the input symbols to the streams is performed in a space dimension.

First, the output of the MIMO encoder 201 may be expressed by an Mₜ×N_{F} MIMO Space Time Coding (STC) matrix as shown in Equation 2.

x=S(S) Equation 2

At this time, Mₜ denotes the number of streams, and N_{F} denotes the number of subcarriers occupied by one MIMO block. x denotes the output of the MIMO encoder 201, S denotes an input layer vector, and S(s) denotes a STC matrix.

In addition, x is expressed by a matrix as shown in Equation 3.

$$X = [ \begin{matrix}{x}_{1 , 1} & {x}_{1 , 2} & … & {x}_{1 , {N}_{F}} \\ {x}_{2 , 1} & {x}_{2 , 2} & … & {x}_{2 , {N}_{F}} \\ ⋮ & ⋮ & ⋱ & ⋮ \\ {x}_{{M}_{t , 1}} & {x}_{{M}_{t , 2}} & … & {x}_{{M}_{t} , {N}_{F}}\end{matrix} ] \qquad Equation 3$$

In an SU-MIMO transmission, an STC rate is defined by Equation 4.

$$R = \frac{M}{{N}_{F}} \qquad Equation 4$$

In a MU-MIMO transmission, an STC rate per layer is 1.

As the format of the MIMO encoder 210, Space Frequency Block Code (SFBC) encoding, Vertical Encoding (VE) and Horizontal Encoding (HE) can be utilized.

In the SFBC encoding, the input to the MIMO encoder 201 may be expressed by a 2×1 vector as shown in Equation 5.

$$s = [ \begin{matrix}{s}_{1} \\ {s}_{2}\end{matrix} ] \qquad Equation 5$$

The MIMO encoder 201 generates an SFBC matrix shown in Equation 6.

$$x = [ \begin{matrix}{s}_{1} & - {s}_{2}^{*} \\ {s}_{2} & {s}_{1}^{*}\end{matrix} ] \qquad Equation 6$$

At this time, x denotes a 2×2 matrix, and a SFBC matrix x occupies two consecutive subcarriers.

In the VE, the input and the output of the MIMO encoder 201 are expressed by an M×1 vector as shown in Equation 7.

$$x = s = [ \begin{matrix}{s}_{1} \\ {s}_{2} \\ ⋮ \\ {s}_{M}\end{matrix} ] \qquad Equation 7$$

At this time, sᵢ denotes an i-th input symbol in one batch process, and s₁ . . . sₘ belong to the same layer with respect to the VE.

In the HE, the input and the output of the MIMO encoder 201 are expressed by an M×1 vector as shown in Equation 8.

$$x = s = [ \begin{matrix}{s}_{1} \\ {s}_{2} \\ ⋮ \\ {s}_{M}\end{matrix} ] \qquad Equation 8$$

At this time, sᵢ denotes an i-th input symbol in one batch process, and s₁ . . . sₘ belong to different layers with respect to the HE.

A method of mapping streams to antennas will now be described in detail.

The mapping of the streams to the antennas is performed by the precoder 202. The output of the MIMO encoder 201 is multiplied by W of the Nₜ×Mₜ precoder. The output of the precoder is expressed by an Nₜ×N_{F} matrix z. The method of mapping the streams to the antennas is expressed by Equation 9.

$$z = Wx = [ \begin{matrix}{z}_{1 , 1} & {z}_{1 , 2} & … & {z}_{1 , {N}_{F}} \\ {z}_{2 , 1} & {z}_{2 , 2} & … & {z}_{2 , {N}_{F}} \\ ⋮ & ⋮ & ⋱ & ⋮ \\ {z}_{{N}_{t} , 1} & {z}_{{N}_{t} , 2} & … & {z}_{{N}_{t} , {N}_{F}}\end{matrix} ] \qquad Equation 9$$

At this time, Nₜ denotes the number of transmission antennas, and z_{j, k} denotes an output symbol transmitted via a j-th physical antenna on a k-th subcarrier.

Applicable precoding methods include a non-adaptive precoding method and an adaptive precoding method.

In the non-adaptive precoding method, a precoding matrix is an Nₜ×Mₜ matrix W(k). At this time, Nₜ denotes the number of transmission antennas, Mₜ denotes the number of streams, and k denotes a physical index of a subcarrier to which W(k) is applied. The matrix W is selected from a subset of a precoder having a base codebook size N_{W} for a given rank. The matrix W is changed at an interval of N₁P_{SC} consecutive physical subcarriers according to Equation 10, and the matrix W does not depend on the number of subframes. The Nₜ×Mₜ precoding matrix W(k) applied to a subcarrier k is selected from an open loop codebook subset of a rank Mₜ as a codeword of an index i. At this time, i is given by Equation 10.

i=mod(┌k/(N₁P_{SC})−1,N_{w})+1 Equation 10

In an open loop area, the matrix W is changed at an interval of N₁P_{sc} consecutive physical subcarriers except for DC subcarrier and guard subcarriers. A default value of N is N₁. N₂ is optional and the use of N₂ does not require additional signaling.

In contrast, in the adaptive precoding method, the matrix is obtained from feedback of a UE.

Codebook-based precoding (codebook feedback) includes three feedback modes, that is, a base mode, an adaptive mode, and a differential mode.

In Time Division Duplex (TDD) sounding-based precoding, the value of the matrix W is obtained from sounding feedback of the UE. Several downlink MIMO modes may be present and are shown in Table 1.

TABLE 1

| Mode | | |
|---|---|---|
| index | Description | Reference |
| Mode 0 | OL SU-MIMO (SFBC with non-adaptive | |
| | precoder) | |
| Mode 1 | OL SU-MIMO (SM with non-adaptive | |
| | precoder) | |
| Mode 2 | CL SU-MIMO (SM with adaptive precoder) | |
| Mode 3 | OL SU-MIMO (SM with non-adaptive | |
| | precoder) | |
| Mode 4 | CL SU-MIMO (SM with adaptive precoder) | |
| Mode 5-7 | n/a | N/a |

In the SU-MIMO, one Resource Unit (RU) is allocated to one user, and one Forward Error Correction (FEC) block is present in an input terminal of the MIMO encoder 201 (this corresponds to vertical MIMO encoding in a transmitter). In the vertical MIMO encoding, all data streams transmitted via several antennas are generated from one user information bit so as to pass through the same FEC block.

Meanwhile, in the MU-MIMO, one RU may be allocated to multiple users, and a plurality of FEC blocks is present in an input terminal of the MIMO encoder 201 (this corresponds to the horizontal MIMO encoding). In the horizontal MIMO encoding, different symbols transmitted via several antennas are generated from different information bits so as to pass through different FEC blocks and modulation blocks.

In general, if the number of users is small, SU-MIMO performance is good and, if the number of users is large, MU-MIMO performance is good. Each of the SU-MIMO and the MU-MIMO is divided into Closed Loop MIMO (CL-MIMO) and Open Loop MIMO (OL-MIMO). While MIMO technology is applied based on information about the state of a channel established between a UE and a base station in the CL-MIMO technology, MIMO technology is applied for the purpose of diversity gain when there is a limit in feedback information reliability due to a high movement speed in the OL-MIMO technology.

Subchannelization of IEEE 802.16m includes two modes. First is a localized mode, in which a subband Contiguous Resource Unit (CRU) is generally used, and second is a diversity mode, in which a Distributed Resource Unit (DRU) is generally used. A miniband CRU may be used in both the localized and diversity modes.

Although subchannelization includes several modes, conventionally, the precoding matrix W was used without distinction of modes. Since a common precoding matrix is used without considering the characteristics of resources allocated according to the modes, a precoding matrix may not be optimized for each mode.

### SUMMARY OF THE INVENTION

Accordingly, the present invention is directed to a method for setting a precoder in an open loop MIMO system that substantially obviates one or more problems due to limitations and disadvantages of the related art.

An object of the present invention is to provide application of an optimal precoding matrix according to the types of allocated resources.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a feedback method of a user equipment in an open loop Multiple-Input Multiple-Output (MIMO) system includes, receiving, from a base station, one of a plurality of modes determined according to types of resources to be used for performing feedback; and selecting a precoding matrix from a codebook subset corresponding to the received mode, applying the selected precoding matrix, and transmitting feedback information, wherein different codebook subsets are configured with respect to the plurality of modes, and the codebook subset is configured by extracting a predetermined number of elements from a base codebook based on a predetermined criterion considering the characteristics of the modes.

In another aspect of the present invention, a method of allocating resources to a user equipment in an open loop Multiple-Input Multiple-Output (MIMO) system includes, at a base station, notifying the user equipment of one of a plurality of modes indicating types of resources to be used when the user equipment transmits feedback information; receiving the feedback information to which a precoding matrix selected from a codebook subset corresponding to the notified mode is applied; and allocating the resources to the user equipment using the received feedback information, wherein different codebook subsets are configured with respect to the plurality of modes, and the codebook subset is configured by extracting a predetermined number of elements from a base codebook based on a predetermined criterion considering the characteristics of the modes.

In another aspect of the present invention, a user equipment for transmitting feedback information in an open loop Multiple-Input Multiple-Output (MIMO) system includes a reception unit configured to receive one of a plurality of modes determined according to types of resources to be used for performing feedback from a base station; a processing unit configured to select a precoding matrix from a codebook subset corresponding to the received mode, to apply the selected precoding matrix, and to generate the feedback information; and a transmission unit configured to transmit the generated feedback information, wherein the reception unit, the processing unit and the transmission unit are electrically connected, different codebook subsets are configured with respect to the plurality of modes, and the codebook subset is configured by extracting a predetermined number of elements from a base codebook based on a predetermined criterion considering the characteristics of the modes.

The plurality of modes may include a localized mode and a diversity mode, a subband Contiguous Resource Unit (CRU) may be used as a logical resource unit upon transmission in the localized mode, and a Distributed Resource Unit (DRU) or subband CRU may be used as a logical resource unit upon transmission in the diversity mode.

A codebook subset corresponding to the localized mode may be configured by extracting a predetermined number of elements satisfying constant modulus characteristics from the base codebook.

A codebook corresponding to the diversity mode may be configured by extracting a predetermined number of elements for maximizing a chordal distance from the base codebook.

According to the present invention, system performance can be improved by an optimal precoder according to types of allocated resources.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram showing the configuration of a general Multiple-Input Multiple-Output (MIMO) system;

FIG. 2 is a diagram showing the architecture of downlink MIMO in a transmitter;

FIG. 3 is a diagram illustrating a process of mapping Physical Resource Units (PRUs) to Logical Resource Units (LRUs);

FIG. 4 is a flowchart illustrating a method of allocating resources in downlink according to an embodiment of the present invention;

FIG. 5 is a flowchart illustrating a method of transmitting data in uplink according to an embodiment of the present invention; and

FIG. 6 is a block diagram showing the configuration of a device which is applied to a base station and a User Equipment (UE) and is able to perform the above methods.

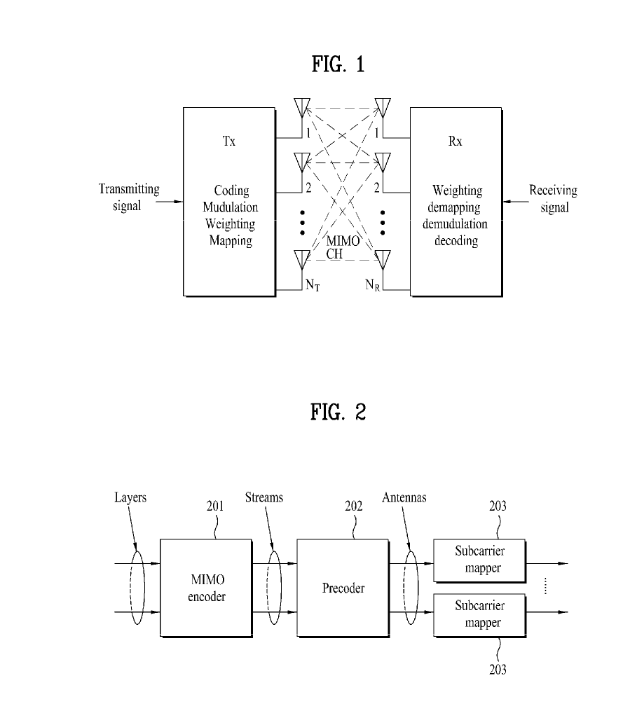

### DETAILED DESCRIPTION OF THE INVENTION

Reference will now be made in detail to the preferred embodiments of the present invention, examples of which are illustrated in the accompanying drawings.

The following embodiments are proposed by combining constituent components and characteristics of the present invention according to a predetermined format. The individual constituent components or characteristics should be considered to be optional factors on the condition that there is no additional remark. If required, the individual constituent components or characteristics may not be combined with other components or characteristics. Also, some constituent components and/or characteristics may be combined to implement the embodiments of the present invention. The order of operations disclosed in the embodiments of the present invention may be rearranged. Some components or characteristics of any embodiment may also be included in other embodiments, or may be replaced with those of the other embodiments as necessary.

In the description of the drawings, procedures or steps which render the scope of the present invention unnecessarily ambiguous will be omitted and procedures or steps which can be understood by those skilled in the art will be omitted.

It should be noted that specific terms disclosed in the present invention are proposed for convenience of description and better understanding of the present invention, and the use of these specific terms may be changed to another format within the technical scope or spirit of the present invention.

First, resources used in a wireless mobile communication system will be described.

In the wireless mobile communication system, generally, resources are divided into a first region and a second region. The first region is suitable for being applicable to obtain diversity by distributing resources allocated in an actual physical zone in terms of a frequency. The second region is advantageous to a user having a relatively good channel by arranging resources consecutively in terms of a frequency.

As an actual example, in the case of IEEE 802.16e, the former is provided as Partial Usage of Subchannel (PUSC) or Full Usage of Subchannel (FUSC) and the latter is serviced as a band Adaptive Modulation and Coding Scheme (AMC).

Meanwhile, in the case of IEEE 802.16m, the former is divided by a Distributed Resource Unit (DRU) and the latter is divided by a Contiguous Resource Unit (CRU), both of which may coexist in one subframe. A Physical Resource Unit (PRU) is a basic physical unit for resource allocation and a Logical Resource Unit (LRU) is a basic logical unit. The DRU and the CRU belong to the LRU. The DRU includes a group of subcarriers which are scattered in distributed resource allocation zones within a frequency partition. The CRU includes a group of contiguous subcarriers in all resource allocation zones.

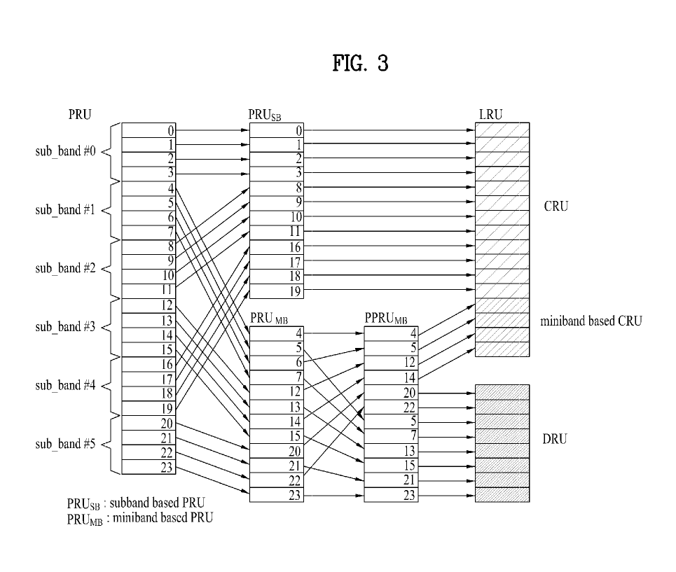

FIG. 3 is a diagram illustrating a process of mapping PRUs to LRUs.

Hereinafter, the process of mapping the PRUs to the LRUs will be described with reference to FIG. 3.

As shown in FIG. 3, first, the PRUs are divided into subband based PRUs and miniband based PRUs. In FIG. 3, the subband based PRU is denoted by PRU_{SB} and the miniband based PRU is denoted by PRU_{MB}. The PRU_{SB} is suitable for frequency selective allocation, because PRUs are continuously allocated on a frequency axis. In addition, the PRU_{MB} is suitable for frequency diversity allocation and is permutated on a frequency axis.

The PRU_{SB} is mapped to the CRU, and the CRU to which the PRU_{SB} is mapped is defined as a subband based CRU. The PRU_{MB} is mapped to the DRU through a permutation process (In FIG. 3, the permutated PRU_{MB} is denoted by PPRU_{MB}). At this time, some of the PPRU_{MB} is mapped to the CRU, and the CRU to which the PPRU_{MB} is mapped is defined as a miniband based CRU.

In addition, a resource zone actually allocated to a UE corresponds to any one of the subband based CRU, miniband based CRU or DRU. In the case of a rapidly moving UE, since channel state is rapidly changed, it is advantageous that resources be allocated to the UE using the DRU or miniband based CRU. Accordingly, in this case, it is preferable that resources are allocated to the UE using the DRU or miniband based CRU. In the case of a UE located in an environment in which a channel state is good and is slowly changed, it is preferable that resources are allocated to the UE using the subband based CRU.

In the case of IEEE 802.16m, subchannelization may be divided into a localized mode and a diversity mode. In general, the subband based CRU is allocated and used in the localized mode and the DRU is allocated and used in the diversity mode. In addition, the miniband CRU may be used in the localized mode or the diversity mode. That is, the type of used resources is changed according to the localized mode and the diversity mode. Moreover, if multiple resources units are allocated to UE in case of miniband based CRU, it generally should be assumed as a diversity mode. Accordingly, it is not preferable for the same precoding matrix to be used regardless of modes, in terms of system performance.

The present invention suggests a method of configuring different codebook subsets according to the localized mode and the diversity mode in order to optimize system performance.

In order to describe the method of configuring codebook subsets optimized according to the modes, it is assumed that C(Nt, Mt, Nw) denotes a codebook, Nt denotes the number of transmission antennas, Mt denotes the number of streams, and Nw denotes the number of codewords of the codebook.

When a codebook used in the localized mode is C_localized (Nt, Mt, Nw1), a Channel Quality Indication (CQI) or Modulation and Coding Scheme (MCS) level may be set on the assumption that transmission is performed using C_localized (Nt, Mt, Nw1) and Equation 10 or precoding is performed using the above codebook. Here, Nt denotes the number of transmission antennas, Mt denotes the number of streams, and Nw1 denotes a number of bits for precoding matrices included in this mode of codebook.

In order to apply a precoding matrix with good performance in the localized mode, C_localized (Nt, Mt, Nw1) used in the localized mode may be configured by using the same codebook as a CL-MIMO base codebook or extracting a precoding matrix from a CL-MIMO base codebook according to a predetermined criterion.

At this time, in order to configure C_localized (Nt, Mt, Nw1), as the criterion for extracting the precoding matrix from the CL-MIMO codebook, for example, a criterion for extracting only elements having constant modulus characteristics from elements of the CL-MIMO base codebook may be used.

In the diversity mode, a CQI or MCS level may be set on the assumption that transmission is performed using C_diversity (Nt, Mt, Nw2) and Equation 10 or precoding is performed using such a method. Here, Nw2 denotes a number of bits precoding matrices included in this mode of codebook. Nw1 and Nw2 may be different from each other.

When it is assumed that u(Nt, M) is an Nₜ×M unitary matrix and W1 and W2 are elements of u(Nt, M), a chordal distance may be defined as shown in Equation 11.

$$d ( {W}_{1} , {W}_{2} ) = \frac{1}{\sqrt{2}} {‖ {W}_{1} {W}_{1}^{H} - {W}_{2} {W}_{2}^{H} ‖}_{F} \qquad Equation 11$$

As one criterion for selecting a precoding matrix configuring the codebook C_diversity (Nt, Mt, Nw2) used in the diversity mode, matrices for maximizing the chordal distance may be selected from the CL-MIMO codebook. Since the maximization of the chordal distance indicates that matrices present in the codebook successfully operate with respect to various channels, it may be used as a criterion for selecting a precoding matrix configuring the codebook used in the diversity mode.

Hereinafter, a method of extracting a precoding matrix from a base codebook so as to configure a codebook subset according to modes in the case where the number of transmission antennas is 4 and a rank is 2 will be described.

Table 2 shows a base CL-MIMO codebook for configuring a codebook subset according to the diversity mode and the localized mode.

TABLE 2

| | | $C ( 4 , 2 , 6 , m ) = {[ \begin{matrix}{c}_{11} & {c}_{12} & {c}_{13} & {c}_{14} \\ {c}_{21} & {c}_{22} & {c}_{23} & {c}_{24}\end{matrix} ]}^{T}$ | | | |
|---|---|---|---|---|---|
| | | c₁₁ | c₁₂ | c₁₃ | c₁₄ |
| Index | m | c₂₁ | c₂₂ | c₂₃ | c₂₄ |
| 000000 | 0 | 0.5000 | 0.5000 | 0.5000 | 0.5000 |
| | | 0.5000 | −0.5000 | 0.5000 | −0.5000 |
| 000001 | 1 | 0.5000 | 0.5000 | 0.5000 | 0.5000 |
| | | −0.5000 | −0.5000 | 0.5000 | 0.5000 |
| 000010 | 2 | 0.5000 | 0.5000 | 0.5000 | 0.5000 |
| | | −0.5000 | 0.5000 | 0.5000 | −0.5000 |
| 000011 | 3 | 0.5000 | −0.5000 | 0.5000 | −0.5000 |
| | | −0.5000 | −0.5000 | 0.5000 | −0.5000 |
| 000100 | 4 | 0.5000 | −0.5000 | 0.5000 | −0.5000 |
| | | −0.5000 | 0.5000 | 0.5000 | −0.5000 |
| 000101 | 5 | −0.5000 | −0.5000 | 0.5000 | 0.5000 |
| | | −0.5000 | 0.5000 | 0.5000 | −0.5000 |
| 000110 | 6 | 0.5000 | 0.5000i | 0.5000 | 0.5000i |
| | | −0.5000 | −0.5000i | 0.5000 | 0.5000i |
| 000111 | 7 | 0.5000 | 0.5000i | 0.5000 | 0.5000i |
| | | −0.5000 | 0.5000i | 0.5000 | −0.5000i |
| 001000 | 8 | 0.5000 | −0.5000i | 0.5000 | −0.5000i |
| | | −0.5000 | −0.5000i | 0.5000 | 0.5000i |
| 001001 | 9 | 0.5000 | −0.5000i | 0.5000 | −0.5000i |
| | | −0.5000 | 0.5000i | 0.5000 | −0.5000i |
| 001010 | 10 | 0.5000 | 0.5000 | 0.5000 | 0.5000 |
| | | −0.5000 | −0.5000i | 0.5000 | 0.5000i |
| 001011 | 11 | 0.5000 | 0.5000 | 0.5000 | 0.5000 |
| | | −0.5000 | 0.5000i | 0.5000 | −0.5000i |
| 001100 | 12 | 0.5000 | 0.5000i | 0.5000 | 0.5000i |
| | | −0.5000 | −0.5000 | 0.5000 | 0.5000 |
| 001101 | 13 | 0.5000 | 0.5000i | 0.5000 | 0.5000i |
| | | −0.5000 | 0.5000 | 0.5000 | −0.5000 |
| 001110 | 14 | 0.5000 | 0.5000 | 0.5000 | −0.5000 |
| | | 0.5000 | −0.5000 | 0.5000 | 0.5000 |
| 001111 | 15 | 0.5000 | −0.3536 + 0.3536i | −0.5000i | 0.3536 + 0.3536i |
| | | 0.5000 | 0.3536 − 0.3536i | −0.5000i | −0.3536 − 0.3536i |
| 010000 | 16 | 0.5000 | −0.5000 | 0.5000 | −0.5000 |
| | | −0.5000 | −0.5000i | 0.5000 | 0.5000i |
| 010001 | 17 | 0.5000 | −0.5000 | 0.5000 | −0.5000 |
| | | −0.5000 | 0.5000i | 0.5000 | −0.5000i |
| 010010 | 18 | 0.5000 | −0.5000 | 0.5000 | −0.5000 |
| | | 0.5587 | 0.3361 + 0.2735i | −0.3361 − 0.2735i | −0.1135 − 0.5471i |
| 010011 | 19 | −0.5000 | −0.5000 | 0.5000 | 0.5000 |
| | | 0.5000 | −0.5000 | 0.5000 | −0.5000 |
| 010100 | 20 | −0.5000 | −0.5000 | 0.5000 | 0.5000 |
| | | 0.5587 | −0.3361 − 0.2735i | −0.1135 − 0.5471i | 0.3361 + 0.2735i |
| 010101 | 21 | −0.5000 | −0.5000 | 0.5000 | 0.5000 |
| | | 0.3117 | −0.2452 + 0.3573i | 0.6025 + 0.1995i | 0.5360 + 0.1578i |
| 010110 | 22 | −0.5000 | 0.5000 | 0.5000 | −0.5000 |
| | | 0.5000 | −0.5000i | 0.5000 | −0.5000i |
| 010111 | 23 | 0.5000 | 0.5000 | 0.5000 | −0.5000 |
| | | 0.5000 | 0.5000i | −0.5000 | 0.5000i |
| 011000 | 24 | −0.5000 | 0.5000 | 0.5000 | −0.5000 |
| | | 0.5587 | −0.2990 + 0.0880i | 0.3361 + 0.2735i | 0.5216 + 0.3616i |
| 011001 | 25 | 0.5000 | 0.5000 | 0.5000 | −0.5000 |
| | | 0.5000 | −0.5000i | −0.5000 | −0.5000i |
| 011010 | 26 | 0.5000 | 0.5000 | 0.5000 | −0.5000 |
| | | 0.3117 | −0.2452 − 0.3573i | −0.6025 + 0.1995i | 0.3616 − 0.5216i |
| 011011 | 27 | 0.5000 | 0.5000i | −0.5000 | 0.5000i |
| | | 0.5000 | −0.5000 | 0.5000 | 0.5000 |
| 011100 | 28 | 0.5000 | 0.5000 | −0.5000 | 0.5000 |
| | | 0.5587 | 0.0880 + 0.2990i | −0.3361 − 0.2735i | 0.3616 − 0.5216i |
| 011101 | 29 | 0.5000 | −0.5000 | 0.5000 | 0.5000 |
| | | 0.5000 | −0.5000i | −0.5000 | −0.5000i |
| 011110 | 30 | 0.5000 | −0.5000 | 0.5000 | 0.5000 |
| | | 0.5587 | −0.2990 − 0.0880i | −0.3361 + 0.2735i | 0.5216 − 0.3616i |
| 011111 | 31 | 0.5000 | 0.3536 + 0.3536i | 0.5000i | −0.3536 + 0.3536i |
| | | 0.5000 | −0.3536 + 0.3536i | −0.5000i | 0.3536 + 0.3536i |
| 100000 | 32 | 0.5000 | 0.3536 + 0.3536i | 0.5000i | −0.3536 + 0.3536i |
| | | 0.5000 | −0.3536 − 0.3536i | 0.5000i | 0.3536 − 0.3536i |
| 100001 | 33 | 0.5000 | 0.3536 + 0.3536i | 0.5000i | −0.3536 + 0.3536i |
| | | 0.5000 | 0.3536 − 0.3536i | −0.5000i | −0.3536 − 0.3536i |
| 100010 | 34 | 0.5000 | 0.3536 + 0.3536i | 0.5000i | −0.3536 + 0.3536i |
| | | 0.3117 | 0.0793 − 0.4260i | −0.1995 − 0.6025i | −0.4906 + 0.2674i |
| 100011 | 35 | 0.5000 | −0.3536 + 0.3536i | −0.5000i | 0.3536 + 0.3536i |
| | | 0.5000 | −0.3536 − 0.3536i | 0.5000 | 0.3536 − 0.3536i |
| 100100 | 36 | −0.5000 | 0.5000i | 0.5000 | −0.5000i |
| | | 0.3082 | 0.0104 + 0.3151i | 0.4077 + 0.4887i | −0.4783 + 0.4145i |
| 100101 | 37 | 0.5000 | −0.3536 − 0.3536i | 0.5000i | 0.3536 − 0.3536i |
| | | 0.5000 | 0.3536 − 0.3536i | −0.5000i | −0.3536 − 0.3536i |
| 100110 | 38 | 0.5000 | −0.3536 − 0.3536i | 0.5000i | 0.3536 − 0.3536i |
| | | 0.5587 | −0.1492 − 0.2737i | −0.2735 − 0.3361i | −0.6245 + 0.1132i |
| 100111 | 39 | 0.3117 | 0.6025 + 0.1995i | −0.4030 − 0.4903i | −0.1122 − 0.2908i |
| | | −0.5000 | 0.5000 | 0.5000 | −0.5000 |
| 101000 | 40 | 0.3117 | 0.6025 + 0.1995i | −0.4030 − 0.4903i | −0.1122 − 0.2908i |
| | | −0.5000 | 0.5000 | 0.5000 | −0.5000 |
| 101001 | 41 | 0.3117 | −0.6025 − 0.1995i | −0.1122 − 0.2908i | 0.4030 + 0.4903i |
| | | 0.3058 | 0.1901 − 0.6052i | 0.1195 + 0.2866i | 0.4884 − 0.4111i |
| 101010 | 42 | 0.3117 | −0.6025 − 0.1995i | −0.1122 − 0.2908i | 0.4030 + 0.4903i |
| | | 0.5000 | 0.5000 | 0.5000 | 0.5000 |
| 101011 | 43 | 0.3117 | −0.3573 − 0.2452i | 0.6025 − 0.1995i | −0.1578 + 0.5360i |
| | | 0.5000 | 0.5000i | −0.5000 | 0.5000i |
| 101100 | 44 | 0.3117 | 0.2452 + 0.3573i | −0.6025 + 0.1995i | 0.5360 + 0.1578i |
| | | 0.5000 | −0.5000 | 0.5000 | 0.5000 |
| 101101 | 45 | 0.3117 | 0.4260 + 0.0793i | 0.1995 + 0.6025i | 0.2674 + 0.4906i |
| | | 0.5000 | −0.3536 + 0.3536i | −0.5000i | 0.3536 + 0.3536i |
| 101110 | 46 | 0.3117 | −0.0793 + 0.4260i | −0.1995 − 0.6025i | 0.4906 − 0.2674i |
| | | 0.5000 | −0.3536 − 0.3536i | 0.5000i | 0.3536 − 0.3536i |
| 101111 | 47 | 0.3117 | −0.4260 − 0.0793i | 0.1995 + 0.6025i | −0.2674 − 0.4906i |
| | | 0.5000 | 0.3536 − 0.3536i | −0.5000i | −0.3536 − 0.3536i |
| 110000 | 48 | 0.5636 | −0.3332 − 0.2672i | 0.1174 + 0.5512i | −0.3308 − 0.2702i |
| | | 0.5587 | −0.3361 + 0.2735i | −0.1135 − 0.5471i | 0.3361 + 0.2735i |
| 110001 | 49 | 0.5587 | −0.3361 − 0.2735i | −0.1135 − 0.5471i | 0.3361 + 0.2735i |
| | | 0.5587 | 0.2735 − 0.3361i | 0.1135 + 0.5471i | 0.2735 − 0.3361i |
| 110010 | 50 | 0.5587 | 0.2735 − 0.3361i | 0.1135 + 0.5471i | 0.2735 − 0.3361i |
| | | 0.5000 | 0.5000i | 0.5000 | 0.5000i |
| 110011 | 51 | 0.5587 | 0.0880 − 0.2990i | 0.3361 − 0.2735i | −0.3616 + 0.5216i |
| | | 0.5000 | −0.5000i | −0.5000 | −0.5000i |
| 110100 | 52 | 0.5587 | 0.2990 + 0.0881i | −0.3362 + 0.2735i | 0.5216 + 0.3616i |
| | | 0.5587 | −0.2990 − 0.0880i | −0.3361 + 0.2735i | −0.5216 − 0.3616i |
| 110101 | 53 | 0.5636 | 0.2741 − 0.1559i | 0.2672 + 0.3332i | 0.1081 + 0.6236i |
| | | 0.5587 | −0.2737 + 0.1492i | 0.2735 + 0.3361i | −0.1132 − 0.6245i |
| 110110 | 54 | 0.5636 | 0.1559 + 0.2741i | −0.2672 − 0.3332i | 0.6236 − 0.1081i |
| | | 0.5587 | −0.1492 − 0.2737i | −0.2735 − 0.3381i | −0.6245 + 0.1132i |
| 110111 | 55 | 0.3117 | 0.4030 + 0.4903i | −0.6025 − 0.1995i | −0.1122 − 0.2908i |
| | | 0.5000 | 0.5000 | 0.5000 | 0.5000 |
| 111000 | 56 | 0.5000 | 0.1913 + 0.4619i | −0.3536 + 0.3536i | −0.4619 − 0.1913i |
| | | 0.5000 | −0.1913 − 0.4619i | −0.3536 + 0.3536i | 0.4619 + 0.1913i |
| 111001 | 57 | 0.3117 | 0.3117 | 0.4030 − 0.4903i | −0.4030 + 0.4903i |
| | | 0.5000 | −0.5000 | 0.5000 | 0.5000 |
| 111010 | 58 | 0.3117 | 0.3117 | 0.4030 − 0.4903i | −0.4030 + 0.4903i |
| | | 0.3082 | −0.3152 − 0.0036i | 0.4076 − 0.4888i | 0.4040 − 0.4872i |
| 111011 | 59 | 0.3117 | 0.3117i | −0.4030 + 0.4903i | 0.4903 + 0.4030i |
| | | 0.5000 | −0.5000i | −0.5000 | −0.5000i |
| 111100 | 60 | 0.3117 | 0.3117i | −0.4030 + 0.4903i | 0.4903 + 0.4030i |
| | | 0.3082 | 0.0036 − 0.3152i | −0.4076 + 0.4888i | −0.4872 − 0.4040i |
| 111101 | 61 | 0.3117 | 0.2204 + 0.2204i | 0.4903 + 0.4030i | 0.0618 + 0.6317i |
| | | 0.5000 | −0.3536 − 0.3536i | 0.5000i | 0.3536 − 0.3536i |
| 111110 | 62 | 0.3117 | −0.2204 + 0.2204i | −0.4903 − 0.4030i | 0.6317 − 0.0618i |
| | | 0.5000 | 0.3536 − 0.3536i | −0.5000i | −0.3536 − 0.3536i |
| 111111 | 63 | 0.3117 | −0.2204 + 0.2204i | −0.4903 − 0.4030i | 0.6317 − 0.0618i |
| | | 0.3082 | 0.2254 − 0.2204i | −0.4888 − 0.4076i | −0.6302 + 0.0588i |

In the base CL-MIMO codebook shown in Table 2, precoding matrices from m=0 to m=15 satisfy the constant modulus characteristics. That is, in the precoding matrices from m=0 to m=15, since the sums of the output power of the precoding matrix to each antenna are equal, the constant modulus characteristics are satisfied. Accordingly, in the localized mode, the codebook subset can be configured by extracting the precoding matrices from m=0 to m=15. That is, from the base CL-MIMO codebook, the codebook subset C_localized (4, 2, 4) which will be used in the localized mode can be configured.

Meanwhile, in the diversity mode, a codebook subset can be configured by extracting precoding matrices for maximizing a chordal distance. For example, a codebook subset used in the diversity mode can be configured by extracting precoding matrices corresponding to m=23, m=29, m=25 and m=27 satisfying a condition for maximizing the chordal distance from the base SU-MIMO codebook.

Although a description is given based on the base codebook of Table 2, even when the number of transmission antennas and the rank are changed, a codebook subset can be configured according to the modes using the above method.

The operation of the present invention in downlink and uplink will be described.

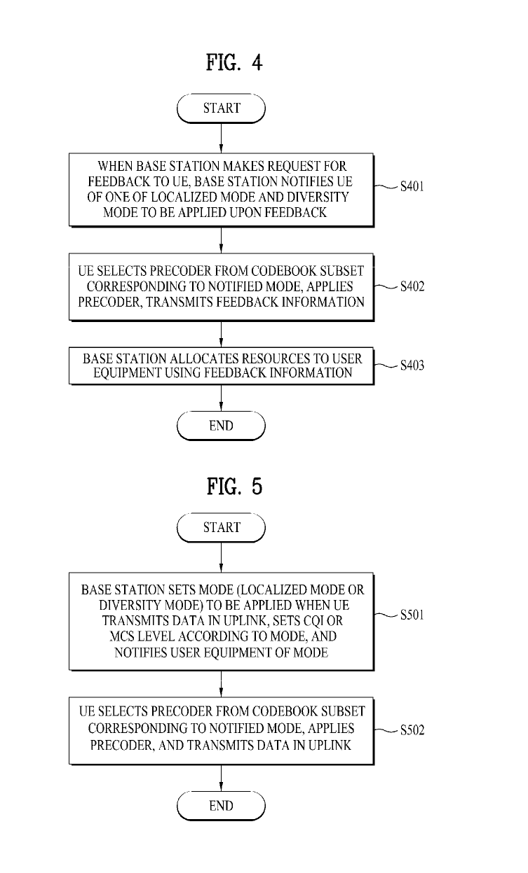

FIG. 4 is a flowchart illustrating a method of allocating resources in downlink according to an embodiment of the present invention. First, in downlink, when a base station makes a request for feedback to a UE, the base station notifies the UE of one of the localized mode and the diversity mode which will be applied when the UE performs feedback (step 401). That is, when the base station makes a request for feedback information to the UE, the base station notifies the UE in which mode (one of the localized mode or the diversity mode) the UE transmits the feedback information. The UE which is notified of the mode along with the request for the feedback selects a precoder from a codebook subset corresponding to the notified mode, applies the precoder, and transmits the feedback information (step 402). The feedback information may correspond to information for setting a CQI or MCS level. The base station allocates resources to the UE using the feedback information (step 403). At this time, as described above, different codebook subsets may be configured according to the modes, and the precoder may be selected from different codebook subsets according to the modes.

FIG. 5 is a flowchart illustrating a method of transmitting data in uplink according to an embodiment of the present invention. In uplink, a base station sets a mode (the localized mode or the diversity mode) which will be applied when a UE transmits data or the like in uplink, sets a CQI or MCS level according to the mode, and notifies the UE of the set mode (step 501). The mode may be directly notified to the UE using control information or may be implicitly notified to the UE according to a subchannelization rule. The UE selects a precoder from a codebook subset corresponding to the notified mode, applies the precoder, and transmits data in uplink (step 502). At this time, as described above, different codebook subsets may be configured according to the modes, and the precoder may be selected from different codebook subsets according to the modes.

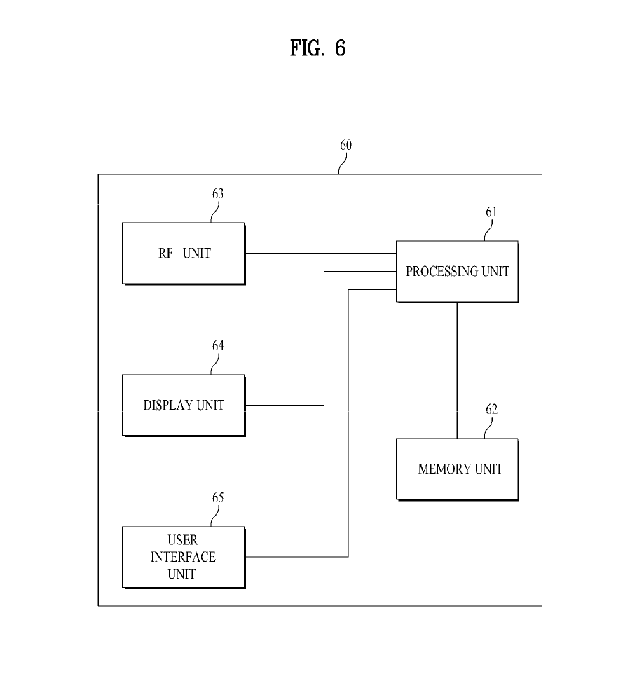

FIG. 6 is a block diagram showing the configuration of a device which is applied to a base station and a User Equipment (UE) and is able to perform the above methods. As shown in FIG. 6, the device 60 includes a processing unit 61, a memory unit 62, a Radio Frequency (RF) unit 63, a display unit 64 and a user interface unit 65. A physical interface protocol layer is provided by the processing unit 61. The processing unit 61 provides a control plane and a user plane. The function of each layer may be performed by the processing unit 61. The memory unit 62 is electrically connected to the processing unit 61 and stores an operating system, applications and general files. If the device 60 is a UE, the display unit 64 can display a variety of information and may be implemented using a known Liquid Crystal Display (LCD), Organic Light Emitting Diode (OLED) or the like. The user interface unit 65 may be configured by a combination of known user interfaces such as a keypad and a touch screen. The RF unit 63 is electrically connected to the processing unit 61 so as to transmit or receive a RF signal.

In other words, it will be obvious to those skilled in the art that various operations for enabling the base station to communicate with the UE in a network composed of several network nodes including the base station will be conducted by the base station or network nodes other than the base station. The term “base station” may be replaced with the term “fixed station”, “Node-B”, “eNode-B (eNB)”, or “access point” as necessary. The term “user equipment” corresponds to a Mobile Station (MS) and the term “MS” may also be replaced with the term “subscriber station (SS)”, “mobile subscriber station (MSS)” or “mobile terminal” as necessary.

Meanwhile, as the UE of the present invention, a Personal Digital Assistant (PDA), a cellular phone, a Personal Communication Service (PCS) phone, a Global System for Mobile (GSM) phone, a Wideband CDMA (WCDMA) phone, or a Mobile Broadband System (MBS) phone may be used.

The embodiments of the present invention can be implemented by a variety of means, for example, hardware, firmware, software, or a combination thereof.

In the case of implementing the present invention by hardware, the present invention can be implemented with application specific integrated circuits (ASICs), Digital Signal Processors (DSPs), Digital Signal Processing Devices (DSPDs), Programmable Logic Devices (PLDs), Field Programmable Gate Arrays (FPGAs), a processor, a controller, a microcontroller, a microprocessor, etc.

If operations or functions of the present invention are implemented by firmware or software, the present invention can be implemented in the form of a variety of formats, for example, modules, procedures, functions, etc. The software codes may be stored in a memory unit so as to be driven by a processor. The memory unit is located inside or outside of the processor, so that it can communicate with the aforementioned processor via a variety of well-known parts.

The present invention is applicable to a user equipment or network equipment used in a wireless access system.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A feedback method of a user equipment in an open loop Multiple-Input Multiple-Output (MIMO) system, the feedback method comprising:
receiving, from a base station, one of a plurality of modes determined according to types of resources to be used for performing feedback; and
selecting a precoding matrix from a codebook subset corresponding to the received mode, applying the selected precoding matrix, and transmitting feedback information,
wherein different codebook subsets are configured with respect to the plurality of modes, and the codebook subset is configured by extracting a predetermined number of elements from a base codebook based on a predetermined criterion considering the characteristics of the modes.

2. The feedback method according to claim 1, wherein the plurality of modes includes a localized mode and a diversity mode, a subband Contiguous Resource Unit (CRU) is used as a logical resource unit upon transmission in the localized mode, and a Distributed Resource Unit (DRU) or miniband based CRU is used as a logical resource unit upon transmission in the diversity mode.

3. The feedback method according to claim 2, wherein a codebook subset corresponding to the localized mode is configured by extracting a predetermined number of elements satisfying constant modulus characteristics from the base codebook.

4. The feedback method according to claim 2, wherein a codebook corresponding to the diversity mode is configured by extracting a predetermined number of elements for maximizing a chordal distance from the base codebook.

5. A method of allocating resources to a user equipment in an open loop Multiple-Input Multiple-Output (MIMO) system, the method comprising:
notifying, at a base station, the user equipment of one of a plurality of modes indicating types of resources to be used when the user equipment transmits feedback information;
receiving the feedback information to which a precoding matrix selected from a codebook subset corresponding to the notified mode is applied; and
allocating the resources to the user equipment using the received feedback information,
wherein different codebook subsets are configured with respect to the plurality of modes, and the codebook subset is configured by extracting a predetermined number of elements from a base codebook based on a predetermined criterion considering the characteristics of the modes.

6. The method according to claim 5, wherein the plurality of modes includes a localized mode and a diversity mode, a subband Contiguous Resource Unit (CRU) is used as a logical resource unit upon transmission in the localized mode, and a Distributed Resource Unit (DRU) or miniband based CRU is used as a logical resource unit upon transmission in the diversity mode.

7. The method according to claim 6, wherein a codebook subset corresponding to the localized mode is configured by extracting a predetermined number of elements satisfying constant modulus characteristics from the base codebook.

8. The method according to claim 6, wherein a codebook corresponding to the diversity mode is configured by extracting a predetermined number of elements for maximizing a chordal distance from the base codebook.

9. A user equipment for transmitting feedback information in an open loop Multiple-Input Multiple-Output (MIMO) system, the user equipment comprising:
a reception unit configured to receive one of a plurality of modes determined according to types of resources to be used for performing feedback from a base station;
a processing unit configured to select a precoding matrix from a codebook subset corresponding to the received mode, to apply the selected precoding matrix, and to generate the feedback information; and
a transmission unit configured to transmit the generated feedback information,
wherein the reception unit, the processing unit and the transmission unit are electrically connected, different codebook subsets are configured with respect to the plurality of modes, and the codebook subset is configured by extracting a predetermined number of elements from a base codebook based on a predetermined criterion considering the characteristics of the modes.

10. The user equipment according to claim 9, wherein the plurality of modes includes a localized mode and a diversity mode, a subband Contiguous Resource Unit (CRU) is used as a logical resource unit upon transmission in the localized mode, and a Distributed Resource Unit (DRU) or miniband based CRU is used as a logical resource unit upon transmission in the diversity mode.

11. The user equipment according to claim 10, wherein a codebook subset corresponding to the localized mode is configured by extracting a predetermined number of elements satisfying constant modulus characteristics from the base codebook.

12. The user equipment according to claim 10, wherein a codebook corresponding to the diversity mode is configured by extracting a predetermined number of elements for maximizing a chordal distance from the base codebook.
